(19) United States
(12) Patent Application Publication
(10) Pub. No.: US 2022/0151141 A1
(43) Pub. Date: May 19, 2022

(54) INDEPENDENT CONTROL SYSTEM FOR ELECTRIC TERRAIN WORKING VEHICLE

(71) Applicant: Excel Industries, Inc., Hesston, KS (US)

(72) Inventors: Brian Lee Nebel, Hesston, KS (US); Royce A. Steinert, Hutchinson, KS (US); Robert C. Esau, Hesston, KS (US)

(21) Appl. No.: 17/526,546

(22) Filed: Nov. 15, 2021

Related U.S. Application Data
(60) Provisional application No. 63/114,274, filed on Nov. 16, 2020.

(51) Int. Cl. A01D 34/00; A01D 34/78; A01D 34/66; A01D 34/82

(52) U.S. Cl. CPC A01D 34/006; A01D 34/78; A01D 2101/00; A01D 34/824; A01D 34/66

(57) ABSTRACT

A control system for an electric, terrain-working vehicle having a left drive wheel powered by a left traction motor, a right drive wheel powered by a right traction motor, at least a first implement powered at least by a first implement motor, and a battery supplying power to the left traction motor, the right traction motor and the first implement motor when certain conditions are met. The control system comprises a first implement controller comprising logic to control the battery-supplied power to the first implement motor; a left traction controller comprising logic to control the battery-supplied power to the left traction motor; and a right traction controller comprising logic to control the battery-supplied power to the right traction motor. The first implement controller, the left traction controller and the right traction controller are independent from one another.

### CROSS-REFERENCE TO RELATED APPLICATIONS

This Application, having attorney docket number 40079.339451 and entitled “Independent Control System for Electric Terrain Working Vehicle,” claims priority to Provisional Application No. 63/114,274, filed Nov. 16, 2020, and entitled, “Independent Control System for Electric Terrain Working Vehicle”. The entirety of the aforementioned application is incorporated herein by reference.

### FIELD

Aspects provided herein relate to control of terrain working vehicles. More particularly, aspects herein relate to an independent control system for electric terrain working vehicles.

### BACKGROUND

At a basic level, a terrain working vehicle may include a traction drive system to drive the vehicle and one or more steering levers to control the traction drive system. The terrain working vehicle may also be equipped with selected implements, such as a mower deck or a blower.

One of the problems facing manufacturers, distributors, dealers, and owners of such electric terrain working vehicles involves challenges in the service environment. In an electric terrain working vehicle with a master control system controlling all aspects of the vehicle, it can be difficult to identify faults or other problems as the faults or issues happen blind within the master control system. As the faults are harder to diagnose or require specialized diagnostic tools, the service expenses associated with these electric terrain working vehicles rises. If the expenses associated with the diagnosis and repair of the electric terrain working vehicles increases or crosses a certain threshold, then (i) the owner may simply decide not to repair the vehicle, or may be influenced based on known repair expenses not to purchase the electric terrain working vehicle in the first place; (ii) the dealer or retailer may be less inclined to purchase such products and could opt for an alternative brand; (iii) the manufacturer can incur higher warranty expenses; or (iv) the manufacturer may have fewer dealers that are able, willing, and qualified to conduct such repairs, thereby decreasing the number of potential retail outlets available thereby decreasing sales.

### SUMMARY

At a high level, an independent control system is provided for an electric terrain working vehicle having a left drive wheel powered by a left traction motor, a right drive wheel powered by a right traction motor, at least a first implement powered at least by a first implement motor, and a battery supplying power to the left traction motor, the right traction motor and the first implement motor, when certain conditions are met. The control system comprises a first implement controller comprising logic to control the battery-supplied power to the first implement motor; a left traction controller comprising logic to control the battery-supplied power to the left traction motor; and a right traction controller comprising logic to control the battery-supplied power to the right traction motor. The first implement controller, the left traction controller and the right traction controller are independent from one another.

In other aspects, an independent control system is provided for an electric, zero-turn, terrain-working vehicle having a left drive wheel powered by a left traction motor and adapted to be controlled by a left steering lever, a right drive wheel powered by a right traction motor and adapted to be controlled by a right steering lever, and a battery supplying power to the left traction motor and the right traction motor, when certain conditions are met. The control system comprises: a left traction controller comprising logic to control the battery-supplied power to the left traction motor; a right traction controller comprising logic to control the battery-supplied power to the right traction motor; a left steering lever signal independently communicatively coupled with, and supplying inputs to, each of the left traction controller and the right traction controller, the left steering lever signal indicating at least a neutral position, a desired forward direction and a desired rearward direction; a right steering lever signal independently communicatively coupled with, and supplying inputs to, each of the left traction controller and the right traction controller, the right steering lever signal indicating at least a neutral position, a desired forward direction and a desired rearward direction. The left traction controller and the right traction controller are independent from one another.

In other aspects, an electric, terrain-working vehicle is provided. The electric terrain-working vehicle comprises: a left drive wheel; a left traction motor powering the left drive wheel; a right drive wheel; a right traction motor powering the right drive wheel; at least a first implement, such as a mower deck; a first implement motor powering the first implement; a battery supplying power to at least the left traction motor, the right traction motor and the first implement motor when certain conditions are met; and a control system. The control system comprises: a first implement controller comprising logic to control the battery-supplied power to the first implement motor; a left traction controller comprising logic to control the battery-supplied power to the left traction motor; and a right traction controller comprising logic to control the battery-supplied power to the right traction motor. The first implement controller, the left traction controller and the right traction controller are independent from one another.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a front right perspective view of an electric terrain working vehicle having an independent control system, in accordance with aspects hereof;

FIG. 2 depicts a front left perspective view of the electric terrain working vehicle of FIG. 1, in accordance with aspects hereof;

FIG. 3 depicts a front bottom right perspective view of the electric terrain working vehicle of FIG. 1, in accordance with aspects hereof;

FIG. 4 depicts an enlarged view of the encircled region of FIG. 1, in accordance with aspects hereof;

FIG. 5 depicts a rear view of the electric terrain working vehicle of FIG. 1, in accordance with aspects hereof;

FIG. 6 is a wiring diagram illustration the independent control system of the electric terrain working vehicle of FIG. 1, in accordance with aspects hereof;

FIG. 7 depicts a system flow diagram illustrating a blade controller logic for controlling the blade motors of the electric terrain working vehicle of FIG. 1, in accordance with aspects hereof;

FIG. 8 is a system flow diagram illustrating a traction controller logic for controlling operation of one of the drive wheels of the electric terrain working vehicle of FIG. 1, in accordance with aspects hereof; and

FIG. 9 is a system flow diagram illustrating implement controller logic for controlling an implement motor of the electric terrain working vehicle of FIG. 1, in accordance with aspects hereof.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other present or future technologies. Further, it should be appreciated that the figures do not necessarily represent an all-inclusive representation of the embodiments herein and may have various components hidden to aid in the written description thereof.

In some aspects, an independent control system is provided for an electric terrain working vehicle having a left drive wheel powered by a left traction motor, a right drive wheel powered by a right traction motor, at least a first implement powered at least by a first implement motor, and a battery supplying power to the left traction motor, the right traction motor and the first implement motor when certain conditions are met. The control system comprises a first implement controller comprising logic to control the battery-supplied power to the first implement motor; a left traction controller comprising logic to control the battery-supplied power to the left traction motor; and a right traction controller comprising logic to control the battery-supplied power to the right traction motor. The first implement controller, the left traction controller and the right traction controller are independent from one another.

In other aspects, an independent control system is provided for an electric, zero-turn, terrain-working vehicle having a left drive wheel powered by a left traction motor and adapted to be controlled by a left steering lever, a right drive wheel powered by a right traction motor and adapted to be controlled by a right steering lever, and a battery supplying power to the left traction motor and the right traction motor, when certain conditions are met. The control system comprises: a left traction controller comprising logic to control the battery-supplied power to the left traction motor; a right traction controller comprising logic to control the battery-supplied power to the right traction motor; a left steering lever signal independently communicatively coupled with, and supplying inputs to, each of the left traction controller and the right traction controller, the left steering lever signal indicating at least a neutral position, a desired forward direction and a desired rearward direction; a right steering lever signal independently communicatively coupled with, and supplying inputs to, each of the left traction controller and the right traction controller, the right steering lever signal indicating at least a neutral position, a desired forward direction and a desired rearward direction. The left traction controller and the right traction controller are independent from one another.

In still other aspects, an electric terrain-working vehicle is provided. The electric terrain-working vehicle comprises: a left drive wheel; a left traction motor powering the left drive wheel; a right drive wheel; a right traction motor powering the right drive wheel; at least a first implement, such as a mower deck; a first implement motor powering the first implement; a battery supplying power to at least the left traction motor, the right traction motor and the first implement motor when certain conditions are met; and a control system. The control system comprises: a first implement controller comprising logic to control the battery-supplied power to the first implement motor; a left traction controller comprising logic to control the battery-supplied power to the left traction motor; and a right traction controller comprising logic to control the battery-supplied power to the right traction motor. The first implement controller, the left traction controller and the right traction controller are independent from one another.

Aspects hereof may be described using directional terminology. For example, the Cartesian coordinate system may be used to describe positions and movement or rotation of the features described herein. Accordingly, some aspects may be described with reference to three mutually perpendicular axes. The axes may be referred to herein as lateral, longitudinal, and vertical, and may be indicated by reference characters X, Y, and Z, respectively, in the accompanying figures. For example, the terms “vertical” and “vertically” as used herein refer to a direction perpendicular to each of the lateral and longitudinal axes. Additionally, relative location terminology will be utilized herein. For example, the term “proximate” is intended to mean on, about, near, by, next to, at, and the like. Therefore, when a feature is proximate another feature, it is close in proximity but not necessarily exactly at the described location, in some aspects. Additionally, the term “distal” refers to a portion of a feature herein that is positioned away from a midpoint of the feature.

As used herein, the term “steering control” and/or “steering lever” generally refers to a control device that moves between a plurality of positions to control any one of the systems described below or any other system controllable by such pivoting as will be recognized by one having skill in the art. For example, in some aspects, “steering control” may comprise actuatable wheels, buttons, knobs, handles, joysticks, or other such mechanical structures configured to pivot, rotate, slide, retract/extend, or any combination of mechanical motions for directing any one of the systems (e.g., a propulsion system of the terrain working vehicle) described herein. Further, such term is not limited to a control device that controls a traction drive system or a steering system of the electric terrain working vehicle.

For the sake of brevity, the figures and description that follow describe the electric terrain working vehicle in reference to a particular embodiment of a zero-turn riding mower. However, the illustrated embodiment is merely one aspect of the present invention, which may be employed on numerous other types of vehicles or mowers having independent control systems (e.g., a stand-on vehicle, a non-zero turn riding vehicle, terrain working vehicles with implements other than a mower deck, etc.).

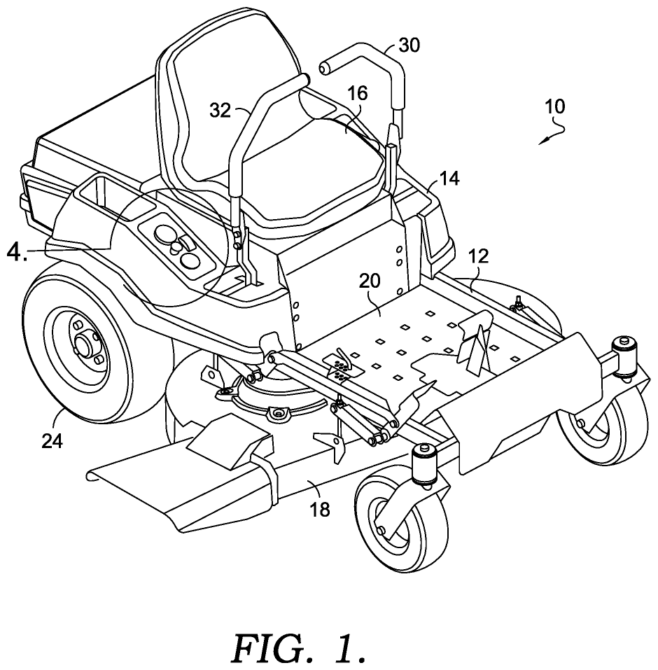

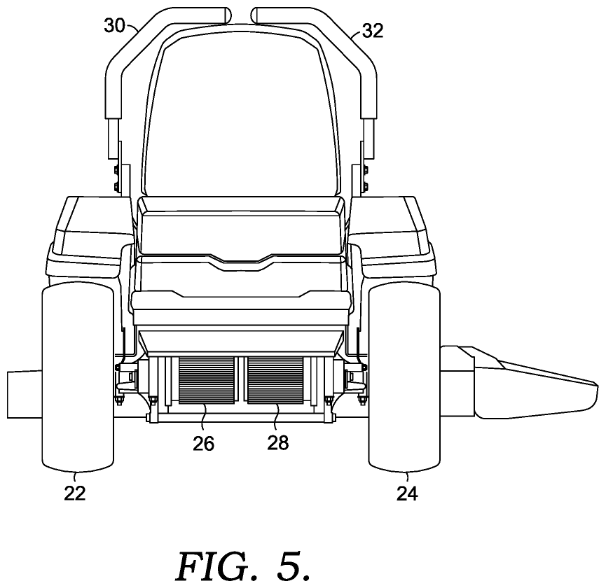

Turning now to the figures generally, and in particular to FIGS. 1-5, the illustrated electric terrain working vehicle is depicted as an electric mower 10. The electric mower 10 is shown as a zero-turn, riding mower having a frame 12, a housing 14 attached to the frame 12 to obscure and/or protect internal componentry (such as a battery, wiring and circuitry), an operator seat 16 coupled to the frame 12, an implement 18 illustrated as a mower deck coupled to the frame 12 and/or a floor pan 20. The electric mower 10 also has a left drive wheel 22 and a right drive wheel 24, both rotatably coupled to the frame 12. The left drive wheel 22 is powered by the output shaft of a left traction motor 26, as best seen in FIG. 5. Similarly, the right drive wheel 24 is powered by the output shaft of a right traction motor 28. A left steering lever 30 and a right steering lever 32 are pivotally coupled to the electric mower 10 for controlling movement of the electric mower 10.

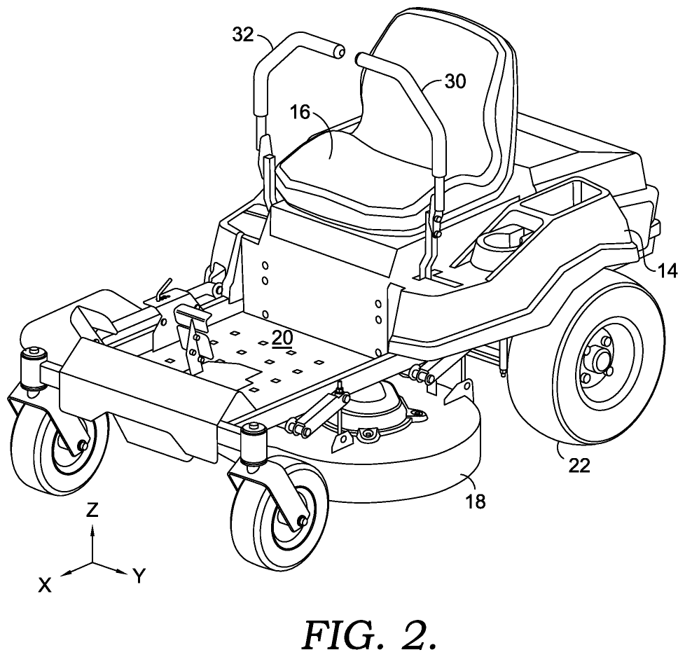

For ease of reference when describing the electric mower 10, and portions thereof, three orthogonal axes are illustrated in FIG. 2. In particular, an X-axis, a Y-axis, and a Z-axis are shown. The X-axis is associated with a longitudinal (e.g., front-to-back) direction of the electric mower 10. The Y-axis is associated with a lateral (e.g., side-to-side) direction of the electric mower 10. The Z-axis is associated with a vertical (e.g., bottom-to-top) direction of the electric mower 10.

The frame 12 of the electric mower 10 may be made of any rigid material for supporting the implement 18, the operator seat 16 and an operator seated therein, and the load associated with the other componentry of the electric mower 10. For example, the frame 12 may be comprised of tube steel (e.g., rectangular tube steel, square tube steel, round tube steel, etc.) or steel formed into other geometries (e.g., C-channels, frame channel, frame rail, sheets, plates, etc.). In other aspects, the frame may be made from materials other than steel. In some aspects, the frame 12 may comprise a vehicle chassis. The housing 14 may comprise a fender made of any rigid (e.g., steel) or non-rigid (e.g., plastic, polymer, etc.) material for obscuring, restricting access to, and shielding some components of the electric mower 10. Additionally, or alternatively, the housing 14 or portions thereof may be integrally formed with the frame 12. The operator seat 16 may be sized and shaped for a human operator to sit thereon, but the operator seat 16 may be omitted without departing from the technology described herein.

The left drive wheel 22 and the right drive wheel 24 may comprise any traditional mechanical wheels, axles, tires, and the like known in the art, and may alternatively comprise any ground-engaging actuation components enabling forward propulsion such as treads or the like. As shown in FIGS. 1-3, the left drive wheel 22 and the right drive wheel 24 are the rear wheels of the electric mower 10. However, in other embodiments, both the front wheels and the rear wheels may serve as drive wheels, or only the front wheels may serve as the drive wheels.

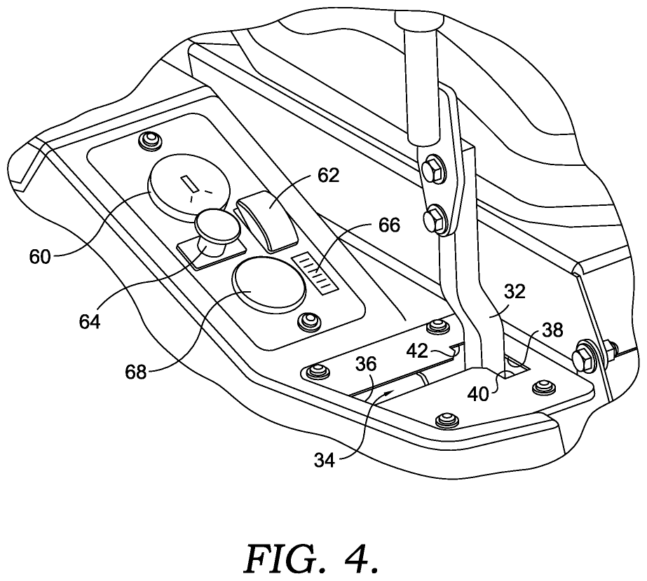

The left steering lever 30 and the right steering lever 32 are movable in a T-shape motion, and may be coupled to a two-axis pivot assembly comprised of polymer or other rigid materials. As best seen in FIG. 4, the steering levers 30, 32 are movable within a T-shape slot 34 in the frame 12 and/or housing 14. In some embodiments, each steering lever 30, 32 may be part of a steering control that includes both a lever and a damping mechanism (e.g., a dashpot, spring, etc.) providing physical resistance to the lever as the lever is moved by a human operator, thereby providing tactile feedback to the human operator. For the sake of brevity, only right steering lever 32 will be discussed below, except as explicitly stated otherwise. However, the following discussion applies equally to the left steering lever 30. When the right steering lever 32 is moved within the T-shape slot 34, certain conditional signals are indicated. As the right steering lever 32 is in the outward position, abutting the outward end 36 of the lateral portion (side-to-side with respect to the electric mower 10) of the T-shape slot 34, a neutral condition is indicated. To move the electric mower 10, and specifically right drive wheel 24, the operator can pivot the right steering lever 32 laterally inwardly abutting the inward end 38 of the lateral portion of the T-shape slot 34. From this position, the operator can pivot the right steering lever 32 to the forward end 40 of the longitudinal portion (front-to-back with respect to electric mower 10) of the T-shape slot 34, to indicate a desired forward direction of rotation for the right drive wheel 24. The operator can also pivot the right steering lever 32 to the rearward end 42 of the longitudinal portion of the T-shape slot 34, to indicate a desired rearward direction of rotation for the right drive wheel 24. Similar motions and signals are achieved using the left steering lever 30 with respect to the left drive wheel 22.

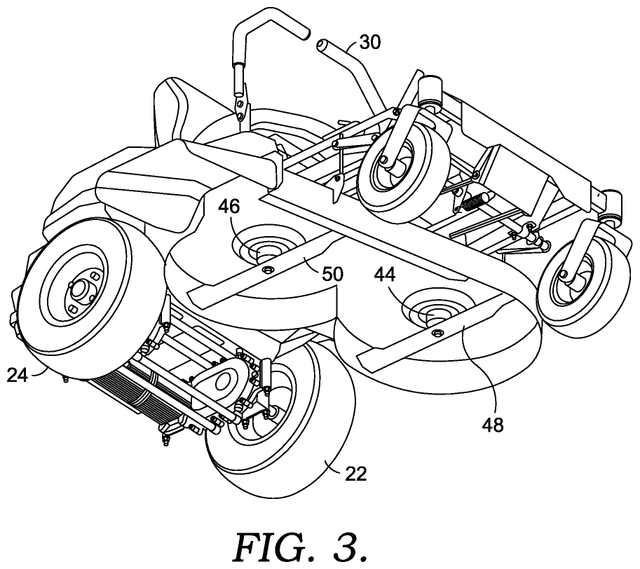

As best seen in FIG. 3, the implement 18, in some aspects, has a left blade motor 44 and a right blade motor 46. The left blade motor 44 has an output shaft that powers a left mower blade 48 and the right blade motor 46 has an output shaft that powers a right mower blade 50. While shown with two mower blades, the implement 18 could also be a mower deck with fewer, or greater, mower blades (such as a single mower blade, or three or more mower blades). Other implements 18 could also be attached to electric mower 10, and in some aspects, each implement 18 may have its own motor.

As best seen in FIG. 4, the electric mower 10 may have various input switches and indicators. More specifically, the electric mower 10 has a key switch 60, a high-low traction speed switch 62, a power-take-off (PTO) switch 64 and a brake. In some aspects, the brake is a mechanically operated brake and may be operated by a foot pedal connected to the brake by a cable. The brake is coupled to a brake switch (discussed below) that is opened or closed depending on whether the brake is engaged or disengaged. In other aspects, the brake may be an electrically operated brake which may be operated by a switch, lever, or a button, for example. In some aspects, the electric mower 10 has a battery charge indicator 66. In some aspects, the battery charge indicator 66 has a series of lights or bands (such as green, yellow, red) to indicate the status of the battery charge. The battery for the electric mower 10, in some aspects, is held within the housing 14 and is rechargeable through recharging port 68.

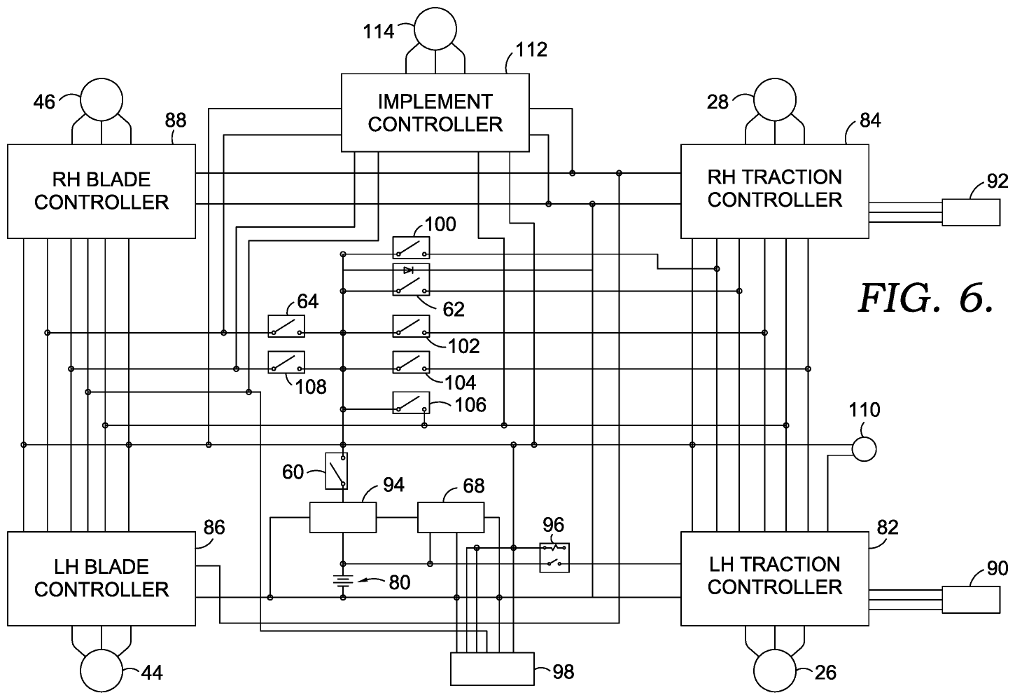

As best seen in FIG. 6, a control system for electric mower 10 shows the battery 80 symbolically. The battery 80 provides power to the components of the electric mower 10. Similarly, the recharging port 68 of the control system is also shown symbolically in FIG. 6. More specifically, the battery 80 provides power to the left traction motor 26, right traction motor 28, left blade motor 44 and right blade motor 46, and in some aspects, an implement motor 114, all of which are shown symbolically in FIG. 6. In some aspects, battery 80 is a forty-eight volt rechargeable (using port 68) lithium-ion battery. The power from battery 80 to each of the left traction motor 26, right traction motor 28, left blade motor 44, right blade motor 46 and implement motor 114 is controlled by an independent controller for each motor. Left traction motor 26 is controlled by logic within a left traction controller 82. Right traction motor 28 is controlled by logic within a right traction controller 84. Left blade motor 44 is controlled by logic within a left blade controller 86. Right blade motor 46 is controlled by logic within a right blade controller 88. Implement motor 114 is controlled by logic within an implement controller 112. Each of the independent controllers 82, 84, 86, 88 and 112 applies logic to received inputs from switches and gauges as described further below. Along with these switches and gauges, the left traction controller 82 also receives input based on the positioning of left steering lever 30, through a left steer sensor 90. Similarly, the right traction controller 84 also receives input based on the positioning of right steering lever 32, through a right steer sensor 92.

FIG. 6 shows the key switch 60 symbolically. The key switch 60 is electrically coupled to the battery 80 through an interlock module 94. The interlock module 94 is a logic device that allows power to flow only when specific components return voltage to the interlock module 94, signaling when certain conditions, described below, are met. The key switch 60 is also electrically coupled to a contactor 96. The key switch 60 provides power to the contactor 96. When the key switch 60 is in the open position, all power supply lines running from the battery 80 are broken, such that power from battery 80 is not available.

The recharging port 68 is shown symbolically in FIG. 6 as well as a battery gauge 98. The battery gauge 98 monitors the charge of the battery 80 and can output the monitored battery charge to battery charge indicator 66, as well as to any of the independent controllers 82, 84, 86, 88 and 112. FIG. 6 also symbolically shows: a brake switch 100 that indicates whether a brake on electric mower 10 is engaged; the high/low traction speed switch 62 that indicates whether the user has selected a high speed or a low speed; a right neutral switch 102 that indicates whether the right steering lever 32 is in the neutral position (so whether right traction motor 28 is in neutral); a left neutral switch 104 that indicates whether the left steering lever 30 is in the neutral position (so whether left traction motor 26 is in the neutral position); and an operator presence switch, such as a seat switch 106, that indicates whether a user is seated on seat 16 or is an otherwise approved operating position. FIG. 6 also symbolically shows the PTO switch 64 that indicates whether the PTO switch 64 is in the on position or the off position.

In some aspects, a deck speed switch 108 is used to toggle between a high speed for left blade motor 44 and right blade motor 46. In other aspects, the deck speed is wired directly into the wiring harness, such that the speed of left blade motor 44 and right blade motor 46 is not selectable but is set at the factory. In one aspect, the speed may be factory set based on the length of the left mower blade 48 and the right mower blade 50, with lower blade speeds being used on mower decks with longer blades, and higher blade speeds being used on mower decks with shorter blades. In one aspect, a higher blade speed may be set for blades having an eighteen inch length, as might be used on a thirty-six inch wide mower deck with two mower blades, or as might be used on a fifty-four inch wide mower deck with three mower blades. In another aspect, a lower blade speed may be set for blades having a twenty-two inch length, as might be used on a forty-four inch mower deck having two blades.

The key switch 60, interlock module 94, contactor 96 and seat switch 106 are each independently electrically coupled to, and supply inputs to, each of the left traction controller 82, the right traction controller 84, the left blade controller 86, the right blade controller 88 and the implement controller 112. The brake switch 100, high/low speed switch 62, right neutral switch 102 and left neutral switch 104 are each independently electrically coupled to, and supply inputs to, left traction controller 82 and right traction controller 84. The PTO switch 64, and the battery gauge 98, along with the deck speed switch 108 (if in use) are each independently electrically coupled to, and supply inputs to, left blade controller 86 and right blade controller 88. The PTO switch 64 and the battery gauge 98 are also electrically coupled to, and supply inputs to, the implement controller 112. In some aspects, as an output, each of the left traction controller 82 and right traction controller 84 are electrically coupled to an audible alert, such as beeper 110.

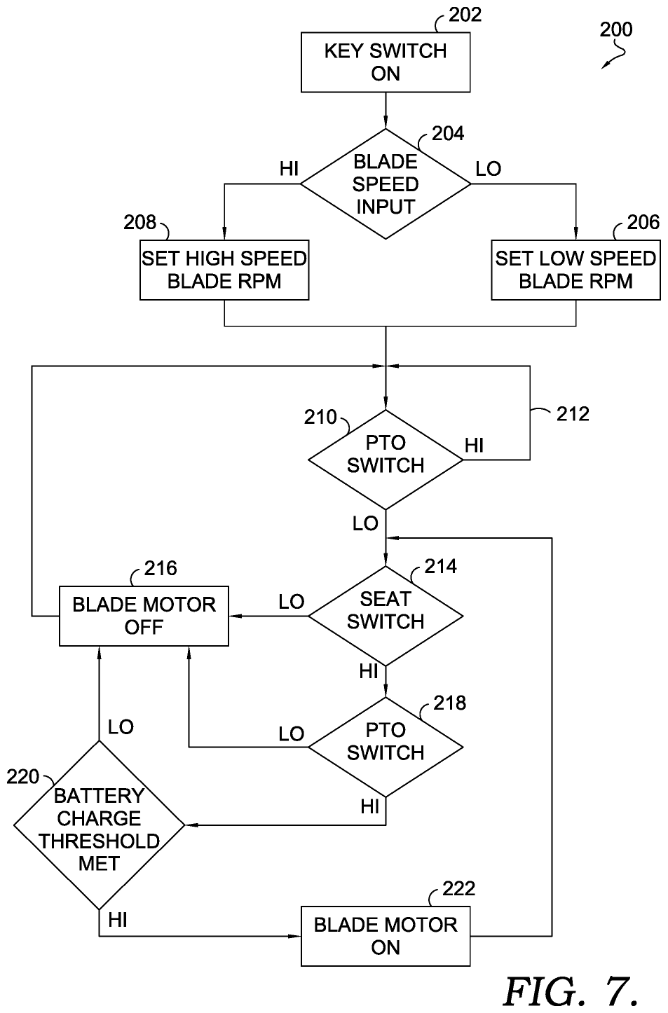

FIG. 7 shows the blade controller logic 200 applied by left blade controller 86 and right blade controller 88. The following discussion describes this logic with respect to only one controller, but the same logic is applied in both the left blade controller 86 and the right blade controller 88. While both blade controllers 86, 88 use the same logic, both are independent from each other. In some aspects, electric mower 10 has only one, larger mower blade. In this aspect, only one blade controller is used. The blade controller logic 200 begins as shown at box 202 by determining whether key switch 60 is activated, or on. In the following description, a switch may be described as activated, or on, when current is allowed to flow through the switch, or may be described as de-activated, or off, when current is not allowed to flow through the switch. If the key switch 60 is not on, the blade controller logic 200 waits until the key switch 60 is on. If the key switch 60 is on, the blade controller logic 200 next determines, at 204, whether the blade speed input signal indicates a high blade speed, or a low blade speed. As described above, this may be hard wired during manufacturing in the wiring harness. By using the wiring harness as the blade speed indicator, one blade controller 86, 88 can be used to accommodate multiple mower deck sizes which adds flexibility in manufacturing and requires less inventory of different controllers. In some aspects, there may also be a deck speed switch 108. If the blade speed input is to be set to low, the blade controller logic 200 will set the blade speed to a low revolutions per minute (RPM) setting, as shown at 206. If the blade speed input is to be set to high, the blade controller logic 200 will set the blade speed to a high RPM, as shown at 208.

With the key switch 60 on, and the proper blade speed determined and set, the blade controller logic 200 next determines if the PTO switch 64 is on, as shown at 210. If the PTO switch is on, the blade controller logic 200 will loop to make sure the PTO switch 64 is first cycled back to the off position, as shown in loop arrow 212. Once the determination is made at 210 that the PTO switch 64 is off, the blade logic 200 continues by checking if an operator presence switch (seat switch 106) is on (indicating a user is in seat 16), as shown at 214. If the seat switch 106 is not on, the blade controller logic 200 signals the blade motor (the respective left blade motor 44 or right blade motor 46) to off, as shown at 216. In some aspects, a delay timer may be used between the seat switch off signal at 214 and the blade motor off signal at 216. If the seat switch 106 is off, at logic step 216 after the blade motor is signaled to be off, the blade controller logic 200 returns to the PTO switch check at 210. If the seat switch 106 is on, the blade controller logic 200 continues by again checking the PTO switch 64 as shown at 218. If the PTO switch 64 is in the off position, the blade controller logic 200 signals the blade motor off as shown at 216, and returns to the PTO switch 64 check at 210. In some aspects, if the PTO switch 64 is on at 218, the blade controller logic 200 next determines if the voltage of battery 80 is above a pre-determined threshold as shown at 220. In one aspect, the threshold may be set at a determined voltage below forty-three volts for three seconds (for a forty-eight volt battery 80). The logic of steps 210, 214 and 218 ensure a proper order of operation of electric mower 10; requiring the PTO switch 64 to be off, the user to be in seat 16, and then the PTO switch 64 turned on. The battery voltage may be determined, in some aspects, by battery gauge 98. If the battery voltage is below the threshold, blade controller logic 200 sets the blade motor to off at 216. If the battery voltage is above the threshold, the blade controller logic 200 signals the respective left blade motor 44 or right blade motor 46 to turn on, as shown at 222. With the respective blade motor (44, 46) on, the blade controller logic 200 loops back to 214. If the user leaves seat 16 (changing seat switch 106), or turns PTO switch 64 off, the blade controller logic 200 will signal the blade motor to turn off, at 216. Further, if the battery 80 charge drops below the set threshold, the blade controller logic 200 will signal the blade motor to turn off, at 216. This protects the electric mower 10 from use in a low battery environment that could damage components of electric mower 10. Additionally, if the user turns the key switch 60 to off, the contactor 96 will cut power to both left blade motor 44 and right blade motor 46. In some aspects, power to stop left mower blade 48 and right mower blade 50 may be stored in a capacitor, such that power is available to stop the respective blade even when power from battery 80 is cut off.

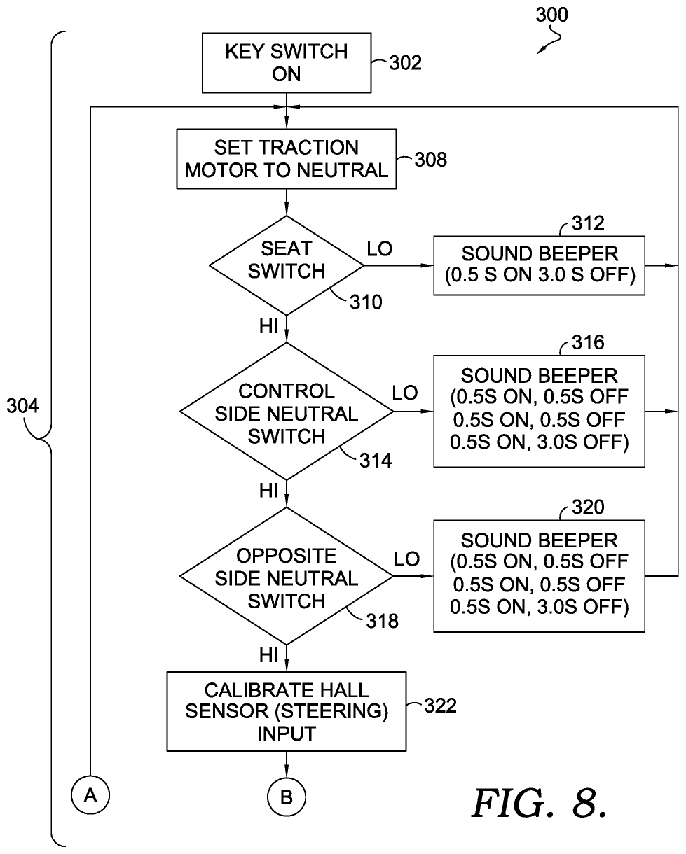

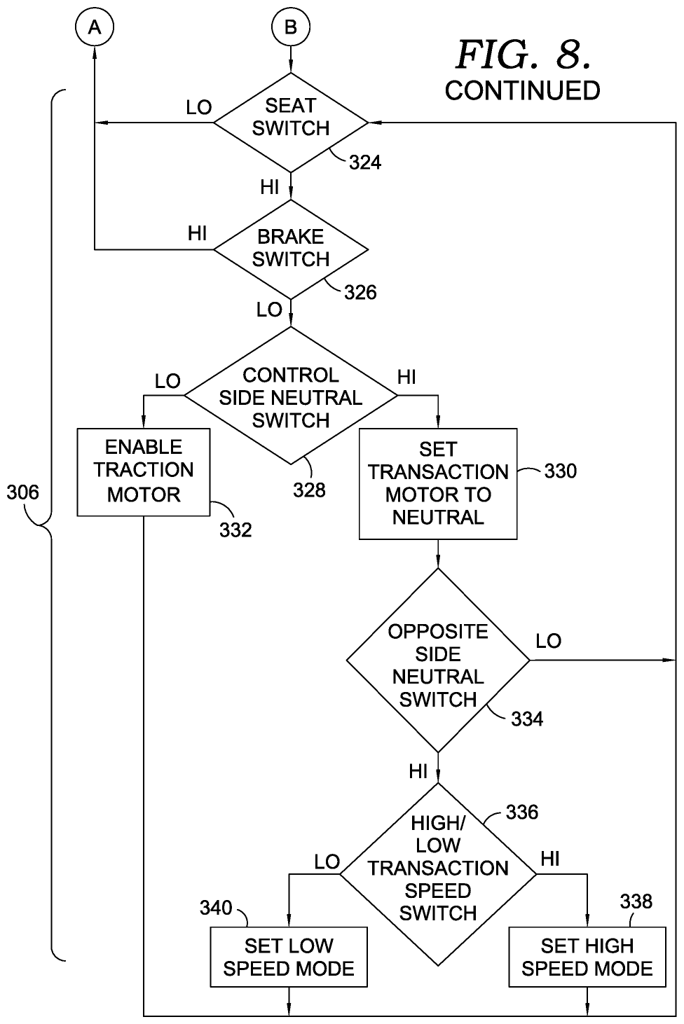

FIG. 8 shows the traction controller logic 300 applied by left traction controller 82 and right traction controller 84. The following discussion describes this logic with respect to only one controller, but the same logic is applied in both the left traction controller 82 and the right traction controller 84. For the left traction controller 82, the “control side” in the following discussion is the left side, and the “opposite side” is the right side. For the right traction controller 84, the control side would be the right side and the opposite side would be the left side. While both traction controllers 82, 84 use the same logic, both are independent from each other. As shown in FIG. 8, the traction controller logic 300 begins as shown at box 302 by determining whether key switch 60 is on. If the key switch 60 is not on, the traction controller logic 300 waits until the key switch 60 is on. If the key switch 60 is on, the traction controller logic 300 begins processing a preparation check sequence 304 before entering a run mode circuit 306.

In the preparation check sequence 304, the traction controller logic 300 first sets the traction motor (the respective left traction motor 26 or right traction motor 28) to neutral as shown at 308. In the following description, the controller logic 300 is described for left traction controller 82. The description applies to right traction controller 84, with the roles of the right hand and left hand reversed. So, the traction controller logic 300 for left traction controller 82 sets the left traction motor 26 to neutral as shown at 308. After the traction controller logic 300 sets the left traction motor 26 to neutral, the traction controller logic 300 checks the operator presence switch (seat switch 106), as shown at 310. If the seat switch 106 is not on (indicating a user is not in seat 16), the traction controller logic 300 signals beeper 110 to emit an audible alarm, as shown at 312. In some aspects, this audible alarm emits a half-a-second beep every three seconds, to alert the user to occupy the seat 16. The traction controller logic 300 then loops back to 308, setting the left traction motor 26 in neutral and continuing to check if seat switch 106 is on. Once seat switch 106 is on, the traction controller logic 300 checks the control side neutral switch, as shown at 314. For the left side, the traction controller logic 300 checks the left neutral switch 104 to determine if the left steering lever 30 is in neutral (in one aspect, making sure left steering lever 30 is in the outward-neutral position 36 and closing left neutral switch 104). If the control side neutral switch indicates the left steering lever 30 is not in the outward-neutral position 36, the traction controller logic 300 signals beeper 110 to emit an audible alarm, as shown at 316. In some aspects, this audible alarm emits two half-a-second beeps, with a half-a-second pause, followed by an additional half-a-second beep with a three second pause. This distinguishes the neutral alarm at 316 from the seat switch alarm at 312. In some aspects, the traction controller logic 300 could signal identical alarms, for simplicity. The traction controller logic 300 then loops back to 308, setting the left traction motor 26 in neutral and continuing to check if seat switch 106 is on, and the control side steering lever (here, left steering lever 30) is in neutral. If the control side neutral switch indicates the left steering lever 30 is in the outward-neutral position 36, the traction controller logic 300 checks the opposite side neutral switch, as shown at 318. For the left side, the traction controller logic 300 checks the right neutral switch 102 to determine if the right steering lever 32 is in neutral (in one aspect, making sure right steering lever 32 is in the outward-neutral position 36 and closing right neutral switch 102). If the opposite side neutral switch indicates the right steering lever 32 is not in the outward-neutral position 36, the traction controller logic 300 signals beeper 110 to emit an audible alarm, as shown at 320. In some aspects, this audible alarm emits two half-a-second beeps, with a half-a-second pause, followed by an additional half-a-second beep with a three second pause (the same audible alarm as described above for the control side neutral alarm at 316). In some aspects, the traction controller logic 300 could signal identical alarms for all alert conditions, for simplicity. The traction controller logic 300 then loops back to 308, setting the left traction motor 26 in neutral and continuing to check if seat switch 106 is on, and the control side steering lever (here, left steering lever 30) is in neutral, and the opposite side steering lever (here right steering lever 32) is in neutral. With the traction motor set to neutral at 308, the seat switch 60 on at 310, the control side steering lever in neutral at 314 and the opposite side steering lever in neutral at 318, the traction controller logic 300 calibrates the left steering sensor 90 to neutral to ensure proper operation of left traction motor 28, as shown at 322. In some aspects, this calibration to neutral is achieved with a Hall Sensor, as described in the patent application titled Steering Control Neutral Calibration for Terrain Working Vehicle, filed Nov. 16, 2020, Patent application Ser. No. 63/114,153, the disclosure of which is hereby incorporated in its entirety. Following the calibration to neutral at 322, the traction controller logic 300 leaves the preparation sequence 304 and enters the run mode circuit 306.

In one embodiment, the run mode circuit 306 begins with traction controller logic 300 confirming that seat switch 106 is on, as shown at 324. If the seat switch 106 is not on, the traction controller logic 300 loops back to 308 and the preparation sequence 304. If the seat switch 106 is on, the traction controller logic 300 continues by checking brake switch 100, as shown at 326. If the brake switch 100 indicates that the brake is on, the traction controller logic 300 will not allow the left traction motor 26 to engage, and the traction controller logic 300 again loops back to 308 and the preparation sequence 304. If the brake switch 100 indicates that the brake is off, the traction controller 300 logic now knows that the left traction motor 26 is set to neutral, the seat 16 is occupied, both steering levers are in neutral and the motor is calibrated to neutral. At this point, the traction controller logic 300 will allow the left traction motor 26 to engage. Before engaging the left traction motor 26, the traction controller logic 300 again checks the control side neutral switch, as shown at 328. In this aspect, the traction controller logic 300 checks the left neutral switch 104. If the left neutral switch 104 is in neutral, the traction controller logic 300 sets the left traction motor 26 to neutral, as shown at 330. If the left neutral switch 104 is not in neutral, the traction controller logic 300 enables the left traction motor 26, as shown at 332. At this point, the left traction motor 26 will operate at the speed setting selected by high/low speed switch 62. The traction controller logic 300 allows left traction motor 26 to run, and spools back to seat switch check 324, looping through a check to make sure the seat 16 is occupied, the brake switch 100 is off, and the left steering lever 30 is not in neutral. Returning to box 330, after the traction controller logic 300 sets the left traction motor 26 to neutral, the traction controller logic 300 checks the opposite side neutral switch, as shown at 334 (here, checking if the right steering lever 32 is in neutral, with right neutral switch 102 closed). If the opposite side neutral switch indicates that the opposite side steering lever is in neutral, the traction controller logic 300 determines the state of high/low speed switch 62, as shown at 336. At this point, the traction controller logic 300 knows that the control side steering lever is in neutral (from 328) and the opposite side steering lever is also in neutral (from 334). With both left steering lever 30 and right steering lever 32 in neutral, the traction controller logic 300 allows a user to change speed settings using the high/low speed switch 62. If the user selects a high speed setting, the traction controller logic 300 sets the left traction motor to the high speed, as shown at 338. If the user selects a low speed setting, the traction controller logic 300 sets the left traction motor to the low speed, as shown at 340. In other aspects, the traction controller logic 300 may allow the speed setting to be changed “on the fly” without requiring both the left steering lever 30 and the right steering lever 32 to be in neutral. In this aspect, the speed setting can be changed or selected by the operator, without requiring the steering levers 30, 32 to be in neutral. So, after the check of the brake switch 326 in FIG. 8, the high/low speed switch can be checked (similarly to that shown at 336), and the traction controller logic 300 sets the respective traction motor to the selected speed and enables the traction motor. At this point, both the left traction controller 82 and the right traction controller 84, using respective traction controller logic 300, will set both the left traction motor 26 (using the left traction controller 82) and the right traction motor 28 (using the right traction controller 84) to the selected speed setting. Once the speed setting is selected, the traction controller logic 300 continues with the run mode circuit 306 at seat switch check 324. If both steering levers (30, 32) are not in neutral, the traction controller logic 300 will not allow a user to change speed settings.

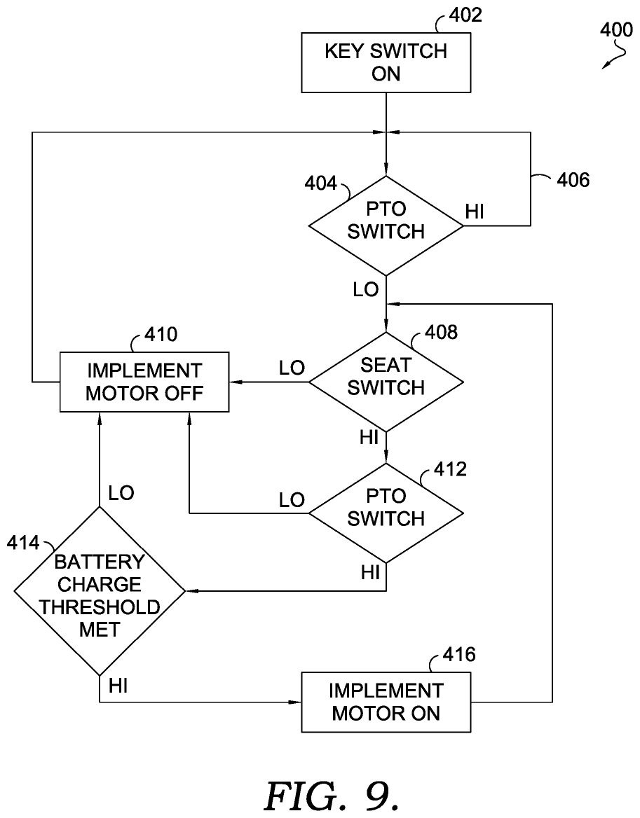

FIG. 9 shows one embodiment of the implement controller logic 400 applied by implement controller 112. The following discussion describes this logic with respect to an implement 18. In some aspects, the implement 18 could be a blower associated with a grass-catching attachment. A variety of other implements could also be used and coupled to the electric mower 10, and could use the implement controller logic 400 to control the respective implement motor 114. While one implement controller 112 and one implement motor 114 are shown in FIG. 9, more than one implement could be attached to electric mower 10, using implement controller logic 400. The implement controller logic 400 begins as shown at box 402 by determining whether key switch 60 is on. If the key switch 60 is not on, the implement controller logic 400 waits until the key switch 60 is on. If the key switch 60 is on, the implement controller logic 400 next determines, at 404, if the PTO switch 64 is on. If the PTO switch 64 is on, the implement controller logic 400 will loop to make sure the PTO switch 64 is first cycled back to the off position, as shown in loop arrow 406. In some aspects, the implement 18 may have a PTO switch that is in common with PTO switch 64, such as a collection blower. In other aspects, the implement 18 may have a different PTO switch from the mower deck (for example, an electric mower 10 with a mid-PTO shaft for the mower deck and a rear PTO shaft for the implement, such as, for example, an auxiliary blower).

Once the determination is made at 404 that the respective PTO switch is off, the implement logic 400 continues by checking if seat switch 106 is on (indicating a user is in seat 16), as shown at 408. If the seat switch 106 is not on, implement controller logic 400 signals the implement motor 114 to off, as shown at 410. If the seat switch 106 is off, at logic step 410 after the implement motor 114 is signaled to be off, the implement controller logic 400 returns to the PTO switch check at 404. If the seat switch 106 is on, the implement controller logic 400 continues by again checking the PTO switch 64 as shown at 412. If the PTO switch 64 is in the off position, the implement controller logic 400 signals the implement motor 114 off as shown at 410, and returns to the PTO switch 64 check at 404. If the PTO switch 64 is on at 412, the implement controller logic 400 next determines if the voltage of battery 80 is above a pre-determined threshold as shown at 414. In one aspect, the threshold may be set at a determined voltage below forty-three volts for three seconds. In other aspects, the threshold for implement motor 114 may be less than the threshold used for the left blade motor 44 and the right blade motor 46. The logic of steps 404, 408 and 412 ensure a proper order of operation of electric mower 10; requiring the PTO switch 64 to be off, the user to be in seat 16, and then the PTO switch 64 turned on. The battery voltage may be determined, in some aspects, by battery gauge 98. If the battery voltage is below the threshold, implement controller logic 400 sets the implement motor 114 to off at 410. If the battery voltage is above the threshold, the implement controller logic 400 signals the implement motor 114 to turn on, as shown at 416. With the implement motor 114 on, the implement controller logic 400 loops back to 408. If the user leaves seat 16 (changing seat switch 106), or turns PTO switch 64 off, the implement controller logic 400 will signal the implement motor 114 to turn off, at 410. Additionally, if the user turns the key switch 60 to off, the contactor 96 will cut power to implement motor 114.

The nature of the control system described above with respect to FIG. 6, as well as the logic of the left traction controller 82, the right traction controller 84, the left blade controller 86, the right blade controller 88 and the implement controller 112 provides the electric mower 10 with a number of independently controlled motors. As noted above, having independent controllers allows issues associated with any of these independent systems to be more-easily diagnosed, making trouble-shooting, maintenance, and warranty more efficient and cost-effective. With this architecture, failures can more often be rectified in a cost-efficient way through replacement as opposed to having to rely on diagnostic tools. Further, to the extent retailers can rely on simply replacing component parts as opposed to utilizing diagnostic technicians, the number of retail outlets willing to sell such products can increase. Moreover, since labor is a significant portion of warranty expense, manufacturer warranty expenses can decrease if diagnostic time is reduced.

Some of the subject matter disclosed herein may be provided as, at least in part, a method, a system, and/or a computer-program product, among other things. Accordingly, certain aspects disclosed herein may take the form of hardware, or may be a combination of software and hardware. A computer-program that includes computer-useable instructions embodied on one or more computer-readable media may also be used. The subject matter hereof may further be implemented as hard-coded into the mechanical design of computing components and/or may be built into a system or apparatus that enables calibration and propulsion of the terrain working vehicle as described herein.

Computer-readable media may include volatile media, non-volatile media, removable media, and non-removable media, and may also include media readable by a database, a switch, and/or various other network devices. Network switches, routers, and related components are conventional in nature, as are methods of communicating with the same, and thus, further elaboration is not provided in this disclosure. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and/or other data representations. Computer storage media may include, but is not limited to, RAM, ROM, EEPROM, flash memory or other memory technology, CD-ROM, digital versatile discs (DVD), holographic media or other optical disc storage, magnetic cassettes, magnetic tape, magnetic disk storage, and other storage devices. These memory components may store data momentarily, temporarily, and/or permanently, and are not limited to the examples provided herein.

Additionally, although some exemplary implementations of the embodiments described herein are shown in the accompanying figures, including, but not limited to the blade controller logic 200, the traction controller logic 300, and the implement controller logic 400, these implementations are not intended to be limiting. Many different arrangements of the various components and steps depicted, as well as components and steps not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

Some aspects of this disclosure have been described with respect to the examples provided in the figures. Additional aspects of the disclosure will now be described that may be related subject matter included in one or more claims or clauses of this application at the time of filing, or one or more related applications, but the claims or clauses are not limited to only the subject matter described in the below portions of this description. These additional aspects may include features illustrated by the figures, features not illustrated by the figures, and any combination thereof. When describing these additional aspects, reference may be made to elements depicted by the figures for illustrative purposes.

As used herein and in connection with the claims listed hereinafter, the terminology “any of clauses” or similar variations of said terminology is intended to be interpreted such that features of claims/clauses may be combined in any combination. For example, an exemplary clause 4 may indicate the method/apparatus of any of clauses 1 through 3, which is intended to be interpreted such that features of clause 1 and clause 4 may be combined, elements of clause 2 and clause 4 may be combined, elements of clause 3 and 4 may be combined, elements of clauses 1, 2, and 4 may be combined, elements of clauses 2, 3, and 4 may be combined, elements of clauses 1, 2, 3, and 4 may be combined, and/or other variations. Further, the terminology “any of clauses” or similar variations of said terminology is intended to include “any one of clauses” or other variations of such terminology, as indicated by some of the examples provided above.

The following clauses are aspects contemplated herein.

Clause 1. A control system for an electric, terrain-working vehicle having a left drive wheel powered by a left traction motor, a right drive wheel powered by a right traction motor, at least a first implement powered at least by a first implement motor, and a battery supplying power to the left traction motor, the right traction motor and the first implement motor when certain conditions are met, the control system comprising: a first implement controller comprising logic to control the battery-supplied power to the first implement motor; a left traction controller comprising logic to control the battery-supplied power to the left traction motor; a right traction controller comprising logic to control the battery-supplied power to the right traction motor; wherein, the first implement controller, the left traction controller and the right traction controller are independent from one another.

Clause 2. The control system of clause 1, wherein the first implement is a mower deck powered by the first implement motor and at least a second implement motor; wherein the first implement motor is a left blade motor powering a left mower blade; and wherein the second implement motor is a right blade motor powering a right mower blade, wherein the first implement controller is a left-blade controller; the control system further comprising a second implement controller that is a right blade controller comprising logic to control the battery-supplied power to the right blade motor.

Clause 3. The control system of any of clauses 1-2, wherein the left blade controller is independent from the right blade controller.

Clause 4. The control system of any of clauses 1-3, further comprising: a key switch independently communicatively coupled with, and supplying inputs to, each of the left traction controller, the right traction controller, the right blade controller and the left blade controller.

Clause 5. The control system of any of clauses 1-4, further comprising: an operator-presence switch independently communicatively coupled with, and supplying inputs to, each of the left traction controller, the right traction controller, the right blade controller and the left blade controller, the operator-presence switch configured to signal a presence of an operator in an approved operating position of the electric, terrain-working vehicle.

Clause 6. The control system of any of clauses 1-5, further comprising: a power take-off switch independently communicatively coupled with, and supplying inputs to, the left blade controller and the right blade controller.

Clause 7. The control system of any of clauses 1-6, wherein, when the key switch, the power take-off switch, and the operator-presence switch are activated, the logic of the left blade controller instructs the left blade motor to operate and the logic of the right blade controller instructs the right blade motor to operate.

Clause 8. The control system of any of clauses 1-7, wherein, when any one of the key switch, the power take-off switch, or the operator-presence switch is deactivated, the left blade controller ceases power to the left blade motor and the right blade controller ceases power to the right blade motor.

Clause 9. The control system of clause 1-8, wherein, when the key switch is activated, the power take-off switch is first de-activated, the operator presence switch is activated, and the power take-off switch is then activated, the logic of the left blade controller instructs the left blade motor to operate and the logic of the right blade controller instructs the right blade motor to operate.

Clause 10. The control system of any of clause 1-9, wherein the electric, terrain-working vehicle has at least a second implement powered at least by a third implement motor, the control system further comprising at least a second implement controller comprising logic to control the battery-supplied power to the third implement motor, wherein the second implement controller is independent from the left blade controller, the right blade controller, the left traction controller and the right traction controller.

Clause 11. The control system of any of clauses 1-10, further comprising: a battery charge indicator independently communicatively coupled with, and supplying inputs to, the left blade controller and the right blade controller, wherein if the battery charge indicator signals a battery charge below a predetermined threshold, the left blade controller ceases power to the left blade motor and the right blade controller ceases power to the right blade motor.

Clause 12. A control system for an electric, zero-turn, terrain-working vehicle having a left drive wheel powered by a left traction motor and adapted to be controlled by a left steering lever, a right drive wheel powered by a right traction motor and adapted to be controlled by a right steering lever, and a battery supplying power to the left traction motor and the right traction motor when certain conditions are met, the control system comprising: a left traction controller comprising logic to control the battery-supplied power to the left traction motor; a right traction controller comprising logic to control the battery-supplied power to the right traction motor; a left steering lever signal independently communicatively coupled with, and supplying inputs to, each of the left traction controller and the right traction controller, the left steering lever signal indicating at least a neutral position, a desired forward direction and a desired rearward direction; a right steering lever signal independently communicatively coupled with, and supplying inputs to, each of the left traction controller and the right traction controller, the right steering lever signal indicating at least a neutral position, a desired forward direction and a desired rearward direction; wherein the left traction controller and the right traction controller are independent from one another.

Clause 13. The control system of clause 12, further comprising: a key switch independently communicatively coupled with, and supplying inputs to, each of the left traction controller and the right traction controller.

Clause 14. The control system of any of clauses 12-13, further comprising: an operator-presence switch independently communicatively coupled with, and supplying inputs to, each of the left traction controller and the right traction controller, the operator-presence switch configured to signal a presence of an operator in the electric, zero-turn, terrain-working vehicle.

Clause 15. The control system of any of clauses 12-14, further comprising: a brake switch independently communicatively coupled with, and supplying inputs to, each of the left traction controller and the right traction controller.

Clause 16. The control system of any of clauses 12-15, wherein, the logic of the left traction controller executes a run mode circuit when the key switch is activated, to determine if the operator presence switch is activated, the brake switch is deactivated, and the left steering signal indicates a forward direction or a rearward direction, and if so, the logic of the left traction controller instructs the left traction controller to enable the left traction motor.

Clause 17. The control system of any of clauses 12-16, wherein, after the logic of the left traction controller determines the key switch is activated, and before executing the run mode circuit, the left traction controller logic executes a preparation sequence that sets the left traction motor to neutral, and then determines if the operator presence switch is activated, and whether the left steering lever signal and the right steering lever signal are both indicating a neutral position.

Clause 18. The control system of any of clauses 12-17, wherein, during the execution of the preparation sequence, if the left traction controller determines that the operator presence switch is de-activated, the left traction control instructs an audible alarm to sound and prevents execution of the run mode circuit.

Clause 19. The control system of any of clauses 12-18, wherein, during the execution of the preparation sequence, if the left traction controller determines that either of the right steering lever signal or the left steering lever signal indicates a desired forward direction or a desired rearward direction, the left traction control instructs an audible alarm to sound and prevents execution of the run mode circuit.

Clause 20. The control system of any of clauses 12-19, wherein the left traction controller calibrates a neutral position of the left steering lever before executing the run mode circuit.

Clause 21. The control system of any of clauses 12-20, wherein, the logic of the left traction controller executes a run mode circuit when the key switch is activated, to determine if the operator presence switch is activated, the brake switch is deactivated, and the left steering signal indicates a neutral position, and if so, the logic of the left traction controller instructs the left traction controller to set the left traction motor to neutral.

Clause 22. The control system of any of clauses 12-21, wherein, the electric, zero-turn, terrain-working vehicle has a high/low speed switch to alter the speed of the left traction motor and the right traction motor, and after setting the left traction motor to neutral in the run mode circuit, the logic of the left traction controller determines whether the right steering signal indicates a neutral position, and if so, the logic of the left traction controller allows the high/low speed switch to alter the speed of the left traction motor.

Clause 23. The control system of any of clauses 12-22, wherein, when any one of the key switch, the operator-presence switch is deactivated, or the brake switch is activated, the left traction controller ceases power to the left traction motor.

Clause 24. An electric, terrain-working vehicle, comprising: a left drive wheel; a left traction motor powering the left drive wheel; a right drive wheel; a right traction motor powering the right drive wheel; at least a first implement; a first implement motor powering the first implement; a battery supplying power to at least the left traction motor, the right traction motor and the first implement motor when certain conditions are met; and a control system comprising: a first implement controller comprising logic to control the battery-supplied power to the first implement motor; a left traction controller comprising logic to control the battery-supplied power to the left traction motor; a right traction controller comprising logic to control the battery-supplied power to the right traction motor; wherein, the first implement controller, the left traction controller and the right traction controller are independent from one another.

Clause 25. The electric, terrain-working vehicle of clause 24, wherein the first implement is a mower deck powered by the first implement motor and at least a second implement motor; wherein the first implement motor is a left blade motor powering a left mower blade; and wherein the second implement motor is a right blade motor powering a right mower blade, wherein the first implement controller is a left-blade controller; the control system further comprising a second implement controller that is a right blade controller comprising logic to control the battery-supplied power to the right blade motor.

Clause 26. The electric, terrain-working vehicle of any of clauses 24-25, wherein the left blade controller is independent from the right blade controller.

Clause 27. The electric, terrain-working vehicle of any of clauses 24-26, further comprising: a key switch independently communicatively coupled with, and supplying inputs to, each of the left traction controller, the right traction controller, the right blade controller and the left blade controller.

Clause 28. The electric, terrain-working vehicle of any of clauses 24-27, further comprising: an operator-presence switch independently communicatively coupled with, and supplying inputs to, each of the left traction controller, the right traction controller, the right blade controller and the left blade controller, the operator-presence switch configured to signal a presence of an operator of the electric, terrain-working vehicle.

Clause 29. The electric, terrain-working vehicle of any of clauses 24-28, further comprising: a power take-off switch independently communicatively coupled with, and supplying inputs to, the left blade controller and the right blade controller.

Clause 30. The electric, terrain-working vehicle of any of clauses 24-29, wherein, when the key switch, the power take-off switch, and the operator-presence switch are activated, the logic of the left blade controller instructs the left blade motor to operate and the logic of the right blade controller instructs the right blade motor to operate.

Clause 31. The electric, terrain-working vehicle of any of clauses 24-30, wherein, when any one of the key switch, the power take-off switch, or the operator-presence switch is deactivated, the left blade controller ceases power to the left blade motor and the right blade controller ceases power to the right blade motor.

Clause 32. The electric, terrain-working vehicle of any of clauses 24-31, wherein, when the key switch is activated, the power take-off switch is first de-activated, the operator presence switch is activated, and the power take-off switch is then activated, the logic of the left blade controller instructs the left blade motor to operate and the logic of the right blade controller instructs the right blade motor to operate.

Clause 33. The electric, terrain-working vehicle of any of clauses 24-32, further comprising at least a second implement powered at least by a third implement motor, the control system further comprising at least a second implement controller comprising logic to control the battery-supplied power to the third implement motor, wherein the second implement controller is independent from the left blade controller, the right blade controller, the left traction controller and the right traction controller.

Clause 34. The electric, terrain-working vehicle of any of clauses 24-33, further comprising: a battery charge indicator independently communicatively coupled with, and supplying inputs to, the left blade controller and the right blade controller, wherein if the battery charge indicator signals a battery charge below a predetermined threshold, the left blade controller ceases power to the left blade motor and the right blade controller ceases power to the right blade motor.

What is claimed is:

1. A control system for an electric, terrain-working vehicle having a left drive wheel powered by a left traction motor, a right drive wheel powered by a right traction motor, at least a first implement powered at least by a first implement motor, and a battery supplying power to the left traction motor, the right traction motor and the first implement motor when certain conditions are met, the control system comprising:
a first implement controller comprising logic to control the battery-supplied power to the first implement motor;
a left traction controller comprising logic to control the battery-supplied power to the left traction motor;
a right traction controller comprising logic to control the battery-supplied power to the right traction motor;
wherein, the first implement controller, the left traction controller and the right traction controller are independent from one another.

2. The control system of claim 1, wherein the first implement is a mower deck powered by the first implement motor and at least a second implement motor; wherein the first implement motor is a left blade motor powering a left mower blade; and wherein the second implement motor is a right blade motor powering a right mower blade, wherein the first implement controller is a left-blade controller; the control system further comprising a second implement controller that is a right blade controller comprising logic to control the battery-supplied power to the right blade motor.

3. The control system of claim 2, wherein the left blade controller is independent from the right blade controller.

4. The control system of claim 3, further comprising:
a key switch independently communicatively coupled with, and supplying inputs to, each of the left traction controller, the right traction controller, the right blade controller and the left blade controller.

5. The control system of claim 4, further comprising:
an operator-presence switch independently communicatively coupled with, and supplying inputs to, each of the left traction controller, the right traction controller, the right blade controller and the left blade controller, the operator-presence switch configured to signal a presence of an operator in an approved operating position of the electric, terrain-working vehicle.

6. The control system of claim 5, further comprising:
a power take-off switch independently communicatively coupled with, and supplying inputs to, the left blade controller and the right blade controller.

7. The control system of claim 6, wherein, when the key switch, the power take-off switch, and the operator-presence switch are activated, the logic of the left blade controller instructs the left blade motor to operate and the logic of the right blade controller instructs the right blade motor to operate.

8. The control system of claim 7, wherein, when any one of the key switch, the power take-off switch, or the operator-presence switch is deactivated, the left blade controller ceases power to the left blade motor and the right blade controller ceases power to the right blade motor.

9. The control system of claim 6, wherein, when the key switch is activated, the power take-off switch is first de-activated, the operator presence switch is activated, and the power take-off switch is then activated, the logic of the left blade controller instructs the left blade motor to operate and the logic of the right blade controller instructs the right blade motor to operate.

10. The control system of claim 2, wherein the electric, terrain-working vehicle has at least a second implement powered at least by a third implement motor, the control system further comprising at least a second implement controller comprising logic to control the battery-supplied power to the third implement motor, wherein the second implement controller is independent from the left blade controller, the right blade controller, the left traction controller and the right traction controller.

11. The control system of claim 2, further comprising:
a battery charge indicator independently communicatively coupled with, and supplying inputs to, the left blade controller and the right blade controller,
wherein if the battery charge indicator signals a battery charge below a predetermined threshold, the left blade controller ceases power to the left blade motor and the right blade controller ceases power to the right blade motor.

12. A control system for an electric, zero-turn, terrain-working vehicle having a left drive wheel powered by a left traction motor and adapted to be controlled by a left steering lever, a right drive wheel powered by a right traction motor and adapted to be controlled by a right steering lever, and a battery supplying power to the left traction motor and the right traction motor when certain conditions are met, the control system comprising:
a left traction controller comprising logic to control the battery-supplied power to the left traction motor;
a right traction controller comprising logic to control the battery-supplied power to the right traction motor;
a left steering lever signal independently communicatively coupled with, and supplying inputs to, each of the left traction controller and the right traction controller, the left steering lever signal indicating at least a neutral position, a desired forward direction and a desired rearward direction;
a right steering lever signal independently communicatively coupled with, and supplying inputs to, each of the left traction controller and the right traction controller, the right steering lever signal indicating at least a neutral position, a desired forward direction and a desired rearward direction;
wherein the left traction controller and the right traction controller are independent from one another.

13. The control system of claim 12, further comprising:
a key switch independently communicatively coupled with, and supplying inputs to, each of the left traction controller and the right traction controller.

14. The control system of claim 13, further comprising:
an operator-presence switch independently communicatively coupled with, and supplying inputs to, each of the left traction controller and the right traction controller, the operator-presence switch configured to signal a presence of an operator in the electric, zero-turn, terrain-working vehicle.

15. The control system of claim 14, further comprising:
a brake switch independently communicatively coupled with, and supplying inputs to, each of the left traction controller and the right traction controller.

16. The control system of claim 15, wherein, the logic of the left traction controller executes a run mode circuit when the key switch is activated, to determine if the operator presence switch is activated, the brake switch is deactivated, and the left steering signal indicates a forward direction or a rearward direction, and if so, the logic of the left traction controller instructs the left traction controller to enable the left traction motor.

17. The control system of claim 16, wherein, after the logic of the left traction controller determines the key switch is activated, and before executing the run mode circuit, the left traction controller logic executes a preparation sequence that sets the left traction motor to neutral, and then determines if the operator presence switch is activated, and whether the left steering lever signal and the right steering lever signal are both indicating a neutral position.

18. The control system of claim 17, wherein, during the execution of the preparation sequence, if the left traction controller determines that the operator presence switch is de-activated, the left traction control instructs an audible alarm to sound and prevents execution of the run mode circuit.

19. The control system of claim 15, wherein, the logic of the left traction controller executes a run mode circuit when the key switch is activated, to determine if the operator presence switch is activated, the brake switch is deactivated, and the left steering signal indicates a neutral position, and if so, the logic of the left traction controller instructs the left traction controller to set the left traction motor to neutral.

20. The control system of claim 22, wherein, when any one of the key switch, the operator-presence switch is deactivated, or the brake switch is activated, the left traction controller ceases power to the left traction motor.
